(19) United States
(12) Patent Application Publication
(10) Pub. No.: US 2007/0200096 A1
(43) Pub. Date: Aug. 30, 2007

(54) Doped lithium quinolate

(76) Inventors: Poopathy Kathirgamanathan, North Harrow (GB); Subramaniam Ganeshamurugan, London (GB); Muttulingham Kumaraverl, Middlesex (GB); Arumugam Partheepan, Surrey (GB); Gnanamoly Paramaswara, London (GB)

Correspondence Address: DAVID SILVERSTEIN;ANOVER-IP-LAW, SUITE 300, 44 PARK STREET, ANDOVER, MA, 01810, US

(21) Appl. No.: 11/732,313

(22) Filed: Apr. 3, 2007

Related U.S. Application Data
(63) Continuation-in-part of application No. 11/140,338, filed on May 27, 2005.
Application No. 11/140,338 is a division of application No. 09/857,300, filed on Jun. 1, 2001, now abandoned.
(63) Continuation-in-part of application No. 10/496,416, filed on May 22, 2004.
(63) Continuation-in-part of application No. PCT/GB06/00441, filed on Feb. 9, 2006.

(30) Foreign Application Priority Data
Nov. 23, 2001 (GB) GB 01 28074.2
Feb. 12, 1998 (GB) GB 98 26406
Feb. 18, 2005 (GB) GB 05 03393.1

(51) Int. Cl. C09K 11/06; H01J 63/04

(52) U.S. Cl. 252/301.16; 313/483

(57) ABSTRACT

An electroluminescent composition is provided comprising (a) lithium quinolate or substituted quinolate exhibiting a blue electroluminescence and being the result of reaction between a lithium alkyl or alkoxide with 8-hydroxy quinoline or a substituted derivative thereof in a solvent which comprises acetonitrile and (b) a dopant. Also provided is an electroluminescent device which comprises sequentially (i) a first electrode (ii) a layer of an electroluminescent material which comprises lithium quinolate or substituted quinolate doped with a dopant and (iii) a second electrode.

### CROSS-REFERENCE TO RELATED APPLICATIONS

This application is a continuation-in-part of: (1) U.S. patent application Ser. No. 11/140,338 filed 27 May 2005 now pending, which was a divisional application of U.S. patent application Ser. No. 09/857,300 filed Jun. 1, 2001, now abandoned, which was derived from International Application No. PCT/GB99/04024 filed 1 Dec. 1999; and also (2) U.S. patent application Ser. No. 10/496,416 filed 22 May 2005, now pending, which was derived from International Application No. PCT/GB02/05268 filed 22 Nov. 2002 and also (3) International Application No. PCT/GB2006/00441 filed 9 Feb. 2006. The entire disclosures of these earlier related applications are incorporated herein by reference.

### FIELD OF THE INVENTION

The present invention relates to doped blue-emitting lithium quinolate compositions, to methods for their manufacture and to novel electroluminescent devices incorporating them.

### BACKGROUND TO THE INVENTION

EP-A-0936844 discloses the use of inter alia lithium quinolate as an electron injection layer of an OLED located between the electroluminescent layer and the cathode. High melting point cathode metals e.g. aluminium are stated under vacuum conditions to be capable of thermally reducing the metal e.g. lithium ions of the organic electron injection layer to metal, with the result that the injection barrier and hence the driving voltage of the device are reduced. In an example, the electroluminescent layer is aluminium quinolate and the emission from the resulting OLED is green.

Various methods for synthesizing lithium 8-hydroxyquinolate and lithium 2-methyl quinolate are discussed by Schnitz et al., Chem. Mater., 2000, 3013 which was sent for publication on Feb. 24, 2000, after the earliest priority date of this application. Reaction of lithium hydroxide and 8-hydroxyquinoline in ethanol does not lead to the desired product because of coordination of ethanol. An alternative method starting from n-butyl lithium and 8-hydroxyquinoline in THF also fails to give the desired product. A yet further method starting from lithium hydroxide and 8-hydroxyquinoline in dichloromethane gives product that is electroluminescent in the green-blue area with CIE coordinates x=0.27, y=0.39. A complete CHN analysis for the fully dried complexes could not be obtained due to their highly hygroscopic nature, and when incorporated as electroluminescent layer in photoluminescent devices, the efficiency of the resulting devices was said to be very low compared to aluminum quinolate devices.

### SUMMARY OF THE INVENTION

The obtaining of blue light in an electroluminescent material is required to enable the complete range of colors to be obtained in devices incorporating such materials.

In one aspect the invention provides an electroluminescent composition comprising:

(a) lithium quinolate which may be unsubstituted or substituted with one or more of alkyl, aryl, fluoro, cyano, amino or alkylamino exhibiting a blue electroluminescence and being the result of reaction between a lithium alkyl or alkoxide with substituted or unsubstituted 8-hydroxy quinoline in a solvent which comprises acetonitrile; and

(b) a dopant.

It is surprising that e.g. lithium quinolate made as described above is pure and readily sublimable, exhibits blue photoluminescence and electroluminescence, and also exhibits surprisingly high electroluminescence efficiency. Further improved performance may be obtained by doping the lithium quinolate or substituted quinolate with a dopant.

In a further aspect the invention provides a method for making a doped lithium quinolate which may be unsubstituted or substituted with one or more of alkyl, aryl, fluoro, cyano, amino or alkylamino and which exhibits blue electroluminescence, which comprises:

(a) reacting a lithium alkyl or alkoxide with substituted or unsubstituted 8-hydroxy quinoline in a solvent which comprises acetonitrile to form the substituted or unsubstituted lithium quinolate; and

(b) adding a dopant.

A further aspect of the invention is the provision of a structure which incorporates a layer of doped lithium quinolate and a means to pass an electric current through the lithium quinolate layer.

In a yet further aspect the invention provides an electroluminescent device which comprises sequentially (i) a first electrode (ii) a layer of an electroluminescent material which comprises lithium quinolate exhibiting a blue electroluminescence and doped with a dopant and (iii) a second electrode.

### BRIEF DESCRIPTION OF THE DRAWINGS

FIGS. 1-16 are graphs indicating the performance of optical light-emitting diodes according to various embodiment of the invention based on blue-emitting lithium quinolate doped with various dopants.

### DESCRIPTION OF PREFERRED EMBODIMENTS

The preferred lithium alkyls are ethyl, propyl and butyl with n-butyl being particularly preferred. With lithium alkoxides preferred are ethoxide, propoxides and butoxides. Preferably the lithium quinolate is made by the reaction of 8-hydroxyquinoline with butyl lithium in a solvent selected from acetonitrile and a mixture of acetonitrile and another liquid The lithium quinolate can be separated by evaporation or when a film of the metal quinolate is required, by deposition onto a suitable substrate.

Unsubstituted quinoline is preferred. As regards substituted quinolines that may be used, examples are 8-hydroxy-2-quinolinecarbonitrile, 8-hydroxy-2-quinolinecarboxaldehyde, 5,7-dimethyl-8-quinolinol, 5-amino-8-hydroxyquinoline, 5 fluoro-8-hydroxyquinoline, 5-cyano-8 hydroxyquinoline, 2-methyl 8-hydroxyquinoline and 2-phenyl 8-hydroxyquinoline.

Cell Structure

An electroluminescent device in accordance with an embodiment of this invention comprises a conductive substrate which acts as the anode, a layer of the electroluminescent material and a metal contact connected to the electroluminescent layer which acts as the cathode. When a current is passed through the electroluminescent layer, the layer emits light.

Preferably the electroluminescent device comprises a transparent substrate, which is a conductive glass or plastic material which acts as the anode. Preferred substrates are conductive glasses such as indium tin oxide coated glass, but any glass which is conductive or has a conductive layer can be used. Conductive polymers and conductive polymer coated glass or plastics materials can also be used as the substrate. In an embodiment, the lithium quinolate can be deposited on the substrate directly by evaporation from a solution in an organic solvent. Any solvent which dissolves the lithium quinolate and dopant can be used e. g. acetonitrile. To form an electroluminescent device incorporating lithium quinolate as the emissive layer there can be a hole transporting layer deposited on the transparent substrate and the lithium quinolate is deposited on the hole transporting layer. The hole transporting layer serves to transport; holes and to block the electrons, thus preventing electrons from moving into the electrode without recombining with holes. The recombination of carriers therefore mainly takes place in the emitter layer. Hole transporting layers are used in polymer electroluminescent devices and any of the known hole transporting materials in film form can be used.

The hole transporting layer can be made of a film of an aromatic amine complex such as poly(vinylcarbazole), N, N′-diphenyl-N, N′-bis(3-methylphenyl)-I, I′-biphenyl-4,4′diamine (TPD), polyaniline etc.

The hole transporting material can optionally be mixed with the lithium quinolate in a ratio of 5-95% of the lithium quinolate to 95 to 5% of the hole transporting compound. In another embodiment of the invention there is a layer of an electron transport material between the cathode and the lithium quinolate layer. This electron transport layer is preferably a metal complex such as a different metal quinolate e. g. an aluminum quinolate or substituted quinolinate which will transport electrons when an electric current is passed through it. Alternatively other electron transport material can be mixed with the lithium quinolate and co-deposited with it.

In another embodiment of the invention there is a layer of an electron transporting material between the cathode and the lithium quinolate layer, this electron transporting layer is preferably a metal complex such as a metal quinolate e. g. an aluminum quinolate which will transport electrons when an electric current is passed through it. Alternatively the electron transporting material can be mixed with the lithium quinolate and co-deposited with it.

In a preferred structure there is a substrate formed of a transparent conductive material which is the anode on which is successively deposited a hole transportation layer, the lithium quinolate layer and an electron transporting layer which is connected to the anode.

The OLEDs of the invention are useful inter alia in flat panel displays and typically comprise an anode and a cathode between which is sandwiched a multiplicity of thin layers including an electroluminescent layer, electron injection and/or transport layer(s), hole injection and/or transport layer(s) and optionally ancillary layers. The layers are typically built up by successive vacuum vapor deposition operations.

A typical device comprises a transparent substrate on which are successively formed an anode layer, a hole injector (buffer) layer, a hole transport layer, an electroluminescent layer, an electron transport layer, an electron injection layer and an anode layer which may in turn be laminated to a second transparent substrate. Top emitting OLEDs are also possible in which an aluminum or other metallic substrate carries an ITO layer, a hole injection layer, a hole transport layer, an electroluminescent layer, an electron transport layer, an electron injection layer and an ITO or other transparent cathode, light being emitted through the cathode. A further possibility is an inverted OLED in which a cathode of aluminum or aluminum alloyed with a low work function metal carries successively an electron injection layer, an electron transport layer, an electroluminescent layer, a hole transport layer, a hole injection layer and an ITO or other transparent conductive anode, emission of light being through the anode. If desired a hole blocking layer may be inserted e.g. between the electroluminescent layer and the electron transport layer.

Anode

In many embodiments the anode is formed by a layer of doped tin oxide or indium tin oxide coated onto glass or other transparent substrate. Other materials that may be used include antimony tin oxide and indium zinc oxide.

Hole Injection Materials

A single layer may be provided between the anode and the electroluminescent material, but in many embodiments there are at least two layers one of which is a hole injection layer (buffer layer) and the other of which is a hole transport layer, the two layer structure offering in some embodiments improved stability and device life (see U.S. Pat. No. 4,720,432 (VanSlyke et al., Kodak). The hole injection layer may serve to improve the film formation properties of subsequent organic layers and to facilitate the injection of holes into the hole transport layer.

Suitable materials for the hole injection layer which may be of thickness e.g. 0.1-200 nm depending on material and cell type include hole-injecting porphyrinic compounds—see U.S. Pat. No. 4,356,429 (Tang, Eastman Kodak) e.g. zinc phthalocyanine copper phthalocyanine and ZnTpTP, whose formula is set out below:

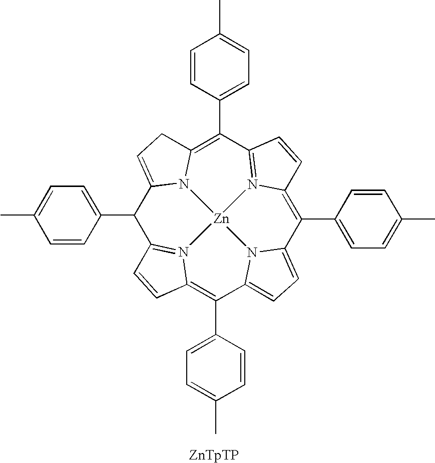

Particularly good device lifetimes may be obtained where the hole injection layer is ZnTpTP and the electron transport layer is zirconium or hafnium quinolate.

The hole injection layer may also be a fluorocarbon-based conductive polymer formed by plasma polymerization of a fluorocarbon gas—see U.S. Pat. No. 6,208,075 (Hung et al; Eastman Kodak), a triarylamine polymer—see EP-A-0891121 (Inoue et al., TDK Corporation) or a phenylenediamine derivative—see EP-A-1029909 (Kawamura et al., Idemitsu).

Hole-Transport Materials

Hole transport layers which may be used are preferably of thickness 20 to 200 nm.

One class of hole transport materials comprises polymeric materials that may be deposited as a layer by means of spin coating or ink jet printing. Such polymeric hole-transporting materials include poly(N-vinylcarbazole) (PVK), polythiophenes, polypyrrole, and polyaniline. Other hole transporting materials are conjugated polymers e.g. poly(p-phenylenevinylene) (PPV) and copolymers including PPV. Other preferred polymers are: poly(2,5dialkoxyphenylene vinylenes e.g. poly(2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group; polyfluorenes and oligofluorenes; polyphenylenes and oligophenylenes; polyanthracenes and oligo anthracenes; and polythiophenes and oligothiophenes.

A further class of hole transport materials comprises sublimable small molecules. For example, aromatic tertiary amines provide a class of preferred hole-transport materials, e.g. aromatic tertiary amines including at least two aromatic tertiary amine moieties (e.g. those based on biphenyl diamine or of a “starburst” configuration), of which the following are representative:

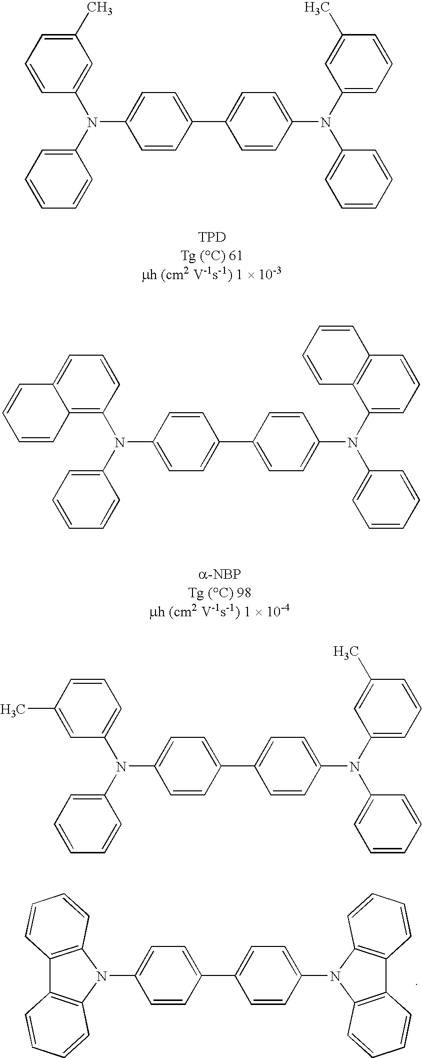

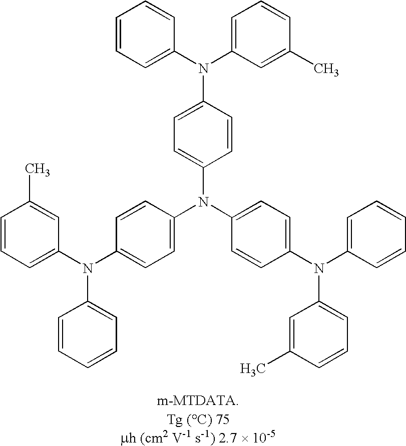

It further includes spiro-linked molecules which are aromatic amines e.g. spiro-TAD (2,2′,7,7′-tetrakis-(diphenylamino)-spiro-9,9′-bifluorene).

A further class of small molecule hole transport materials is disclosed in WO 2006/061594 (Kathirgamanathan et al) and is based on diamino dainthracenes e.g. of formula 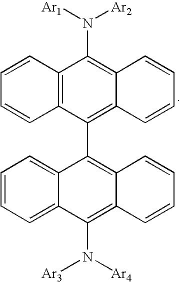
wherein Ar₁-Ar₄ which may be the same or different may be phenyl, biphenyl, naphthyl or 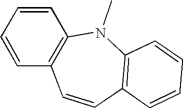
which may optionally be substituted by C₁-C₄ alkyl e.g. methyl or C₁-C₄ alkoxy e.g. methoxy. Typical compounds include:

9-(10-(N-(naphthalen-1-yl)-N-phenylamino)anthracen-9-yl)-N-(naphthalen-1-yl)-N-phenylanthracen-10-amine (Compound Y in the Examples);

9-(10-(N-biphenyl-N-2-m-tolylamino)anthracen-9-yl)-N-biphenyl-N-2-m-tolylamino-anthracen-10-amine; and

9-(10-(N-phenyl-N-m-tolylamino)anthracen-9-yl)-N-phenyl-N-m-tolylanthracen-10-amine.

Electroluminescent Materials

The substituted or unsubstituted lithium quinolate prepared as described above may be doped with dyes such as fluorescent laser dyes, luminescent laser dyes to modify the color spectrum of the emitted light and/or to and also enhance the photoluminescent and electroluminescent efficiencies. The lithium quinolate can also be mixed with a polymeric material such as a polyolefin e. g. polyethylene, polypropylene etc. and preferably polystyrene. It may also be mixed with a conjugated polymer to impart conductivity and/or electroluminescence and/or fluorescent properties.

Preferably the lithium quinolate is doped with a minor amount of a fluorescent or phosphorescent material as a dopant, preferably in an amount of 0.01 to 25% by weight of the doped mixture. The dopant is more preferably present in the lithium quinolate in an amount of 0.01% to 5% by weight e.g. in an amount of 0.01% to 2%.

The doped lithium quinolate can be deposited on a substrate by any conventional method, e.g.

(a) Directly by vacuum evaporation of a mixture of the lithium quinolate and dopant.

(b) Evaporation from a solution in an organic solvent or co evaporation of the lithium quinolate and dopant. The solvent which is used will depend on the material but chlorinated hydrocarbons such as dichloromethane and n-methyl pyrrolidone; dimethyl sulfoxide; tetrahydrofuran; dimethylformamide etc. are suitable in many cases.

(c) Spin coating of the lithium quinolate and dopant from solution.

(d) Sputtering.

(e) Melt deposition.

As discussed in U.S. Pat. No. 4,769,292 (Tang et al., Kodak), the contents of which are included by reference, the presence of the fluorescent material permits a choice from amongst a wide latitude of wavelengths of light emission. In particular, as disclosed in U.S. Pat. No. 4,769,292 by blending with the organometallic complex a minor amount of a fluorescent material capable of emitting light in response to hole-electron recombination, the hue of the light emitted from the luminescent zone, can be modified. In theory, if a lithium quinolate material and a fluorescent material could be found for blending which have exactly the same affinity for hole-electron recombination, each material should emit light upon injection of holes and electrons in the luminescent zone. The perceived hue of light emission would be the visual integration of both emissions. However, since imposing such a balance of lithium quinolate material and fluorescent materials is limiting, it is preferred to choose the fluorescent material so that it provides the favored sites for light emission. When only a small proportion of fluorescent material providing favored sites for light emission is present, peak intensity wavelength emissions typical of the lithium quinolate material can be entirely eliminated in favor of a new peak intensity wavelength emission attributable to the fluorescent material.

While the minimum proportion of fluorescent material sufficient to achieve this effect varies, in no instance is it necessary to employ more than about 10 mole percent fluorescent material, based of lithium quinolate material and seldom is it necessary to employ more than 1 mole percent of the fluorescent material. On the other hand, limiting the fluorescent material present to extremely small amounts, typically less than about 10⁻³ mole percent, based on the lithium quinolate material, can result in retaining emission at wavelengths characteristic of the lithium quinolate material. Thus, by choosing the proportion of a fluorescent material capable of providing favored sites for light emission, either a full or partial shifting of emission wavelengths can be realized. This allows the spectral emissions of the EL devices to be selected and balanced to suit the application to be served. In the case of fluorescent dyes, typical amounts are 0.01 to 5 wt %, for example 2-3 wt %. In the case of phosphorescent dyes typical amounts are 0.1 to 15 wt %. In the case of ion phosphorescent materials typical amounts are 0.01-25 wt % or up to 100 wt %.

Choosing fluorescent materials capable of providing favored sites for light emission, necessarily involves relating the properties of the fluorescent material to those of the lithium quinolate material. The lithium quinolate can be viewed as a collector for injected holes and electrons with the fluorescent material providing the molecular sites for light emission. One important relationship for choosing a fluorescent material capable of modifying the hue of light emission when present in the lithium quinolate is a comparison of the reduction potentials of the two materials. The fluorescent materials demonstrated to shift the wavelength of light emission have exhibited a less negative reduction potential than that of the lithium quinolate. Reduction potentials, measured in electron volts, have been widely reported in the literature along with varied techniques for their measurement. Since it is a comparison of reduction potentials rather than their absolute values which is desired, it is apparent that any accepted technique for reduction potential measurement can be employed, provided both the fluorescent and lithium quinolate reduction potentials are similarly measured. A preferred oxidation and reduction potential measurement techniques is reported by R. J. Cox, Photographic Sensitivity, Academic Press, 1973, Chapter 15.

A second important relationship for choosing a fluorescent material capable of modifying the hue of light emission when present in the lithium quinolate is a comparison of the band-gap potentials of the two materials. The fluorescent materials demonstrated to shift the wavelength of light emission have exhibited a lower band gap potential than that of the lithium quinolate. The band gap potential of a molecule is taken as the potential difference in electron volts (eV) separating its ground state and first singlet state. Band gap potentials and techniques for their measurement have been widely reported in the literature. The band gap potentials herein reported are those measured in electron volts (eV) at an absorption wavelength which is bathochromic to the absorption peak and of a magnitude one tenth that of the magnitude of the absorption peak. Since it is a comparison of band gap potentials rather than their absolute values which is desired, it is apparent that any accepted technique for band gap measurement can be employed, provided both the fluorescent and lithium quinolate band gaps are similarly measured. One illustrative measurement technique is disclosed by F. Gutman and L. E. Lyons, Organic Semiconductors, Wiley, 1967, Chapter 5.

With lithium quinolate made as described above which is itself capable of emitting light in the absence of the fluorescent material, it has been observed that suppression of light emission at the wavelengths of emission characteristics of the lithium quinolate alone and enhancement of emission at wavelengths characteristic of the fluorescent material occurs when spectral coupling of the lithium quinolate and fluorescent material is achieved. By “spectral coupling” it is meant that an overlap exists between the wavelengths of emission characteristic of the lithium quinolate alone and the wavelengths of light absorption of the fluorescent material in the absence of the lithium quinolate. Optimal spectral coupling occurs when the emission wavelength of the lithium quinolate is within ±25nm of the maximum absorption of the fluorescent material alone. In practice advantageous spectral coupling can occur with peak emission and absorption wavelengths differing by up to 100 nm or more, depending on the width of the peaks and their hypsochromic and bathochromic slopes. Where less than optimum spectral coupling between the lithium quinolate and fluorescent materials is contemplated, a bathochromic as compared to a hypsochromic displacement of the fluorescent material produces more efficient results.

Useful fluorescent materials are those capable of being blended with the lithium quinolate and fabricated into thin films satisfying the thickness ranges described above forming the luminescent zones of the EL devices of this invention. While crystalline organometallic complexes do not lend themselves to thin film formation, the limited amounts of fluorescent materials present in the lithium quinolate permit the use of fluorescent materials which are alone incapable of thin film formation. Preferred fluorescent materials are those which form a common phase with the lithium quinolate. Fluorescent dyes constitute a preferred class of fluorescent materials, since dyes lend themselves to molecular level distribution in the lithium quinolate. Although any convenient technique for dispersing the fluorescent dyes in the lithium quinolate can be used preferred fluorescent dyes are those which can be vacuum vapor deposited along with the lithium quinolate materials.

Fluorescent laser dyes are recognized to be particularly useful fluorescent materials for use in the organic EL devices of this invention. Dopants which can be used include diphenylacridine, coumarins, perylene and their derivatives. Useful fluorescent dopants are disclosed in U.S. Pat. No. 4,769,292.

One class of preferred dopants is coumarins e.g. those of the formula: 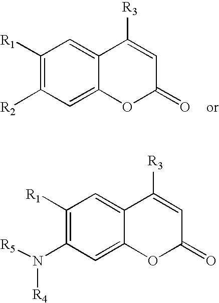
wherein R₁-R₅ represent hydrogen or alkyl e.g. methyl or ethyl. Compounds of this type include 7-hydroxy-2H-chromen-2-one, 7-hydroxy-2-oxo-2H-chromene-3-carbonitrile, 7-hydroxy-4-methyl-2-oxo-2H-chromene-3-carbonitrile, 7-(ethylamino)-4,6-dimethyl-2H-chromen-2-one, 7-amino-4-methyl-2H-chromen-2-one, 7-(diethylamino)-4-methyl-2H-chromen-2-one, 7-hydroxy-4-methyl-2H-chromen-2-one, 7-(dimethylamino)-4-(trifluoromethyl)-2H-chromen-2-one, and 7-(dimethylamino)-2,3-dihydrocyclopenta[c]chromen4(1H)-one. In addition the following dyes may be used:

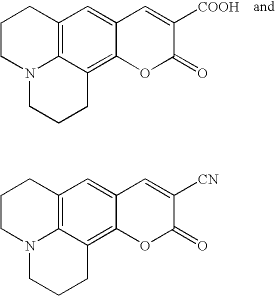

Further dopants that may be used include 3-(benzo[d]thiazol-2-yl)-8-(diethylamino)-2H-benzo[g]chromen-2-one, 3-(1H-benzo[d]imidazol-2-yl)-8-(diethylamino)-2H-benzo[g]chromen-2-one, 9-(pentan-3-yl)-1H-benzo[a]phenoxazin-5(4H,7aH, 12aH)-one and 10-(2-benzothiazolyl)-1,1,7,7-tetramethyl-2,3,6,7-tetrahydro-1H,5H, 11H-[l]benzo-pyrano[6,7,8-ij]quinolizin-11-one (C-545-T) of formula below and analogs such as C-545TB and C545MT:

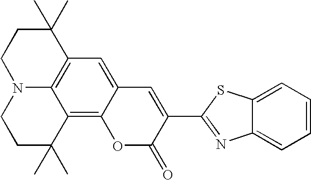

Further dopants that can be used include pyrene and perylene compounds e.g. compounds of one of the formulae below: 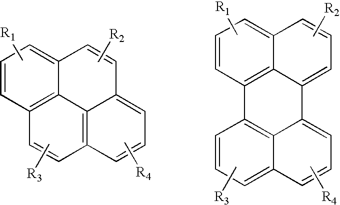
wherein R₁ to R₄ which may be the same or different are selected from hydrogen, hydrocarbyl groups, substituted and unsubstituted aromatic, heterocyclic and polycyclic ring structures, fluorocarbons e.g. trifluoromethyl, halogen e.g. fluorine or thiophenyl or can be substituted or unsubstituted fused aromatic, heterocyclic and polycyclic ring structures. Of the above compounds, preferred are compounds wherein R₁ to R₄ are selected from hydrogen and t-butyl e.g. perylene and tetrakis-t-butyl perylene which because of the steric effects of the t-butyl groups does not crystallize out of the matrix and is of formula:

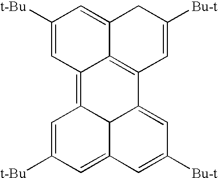

R₁ to R₄ may also be copolymerisable with a monomer e.g. styrene and may be unsaturated alkylene groups such as vinyl groups or groups —CH₂—CH═CH—R wherein R is hydrocarbyl, aryl, heterocyclic, carboxy, aryloxy, hydroxy, alkoxy, amino or substituted amino e.g. styryl. Compounds of this type include polycyclic aromatic hydrocarbons containing at least four fused aromatic rings and optionally one or more alkyl substituents e.g. perylene, tetrakis-(t-butyl)-perylene and 7-(9-anthryl)-dibenzo[α,o]perylene (pAAA) of structure: 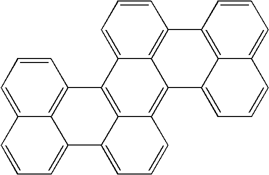
Bis-perylene and dianthry dopants may also be employed.

Other dopants include salts of bis benzene sulfonic acid (require deposition by spin-coating rather than sublimation) such as 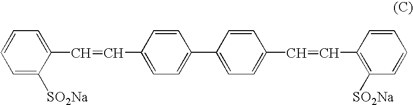
and perylene and perylene derivatives.

Various fluorescent dopants based inter alia on iridium are disclosed in WO 2005/080526, WO 2006/003408, WO 2006/016193, WO 2006/024878 and WO 2006/087521, the disclosures of which are incorporated herein by reference.

For example, the dopant may be a complex of a general formula selected from: 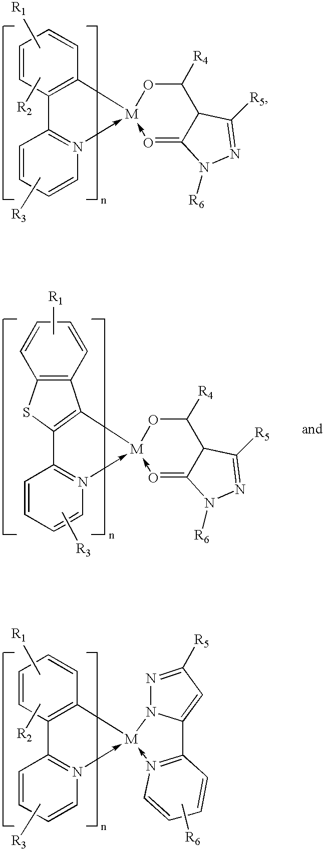
wherein

R₁, R₂, and R₃ which may be the same or different are selected from the group consisting of hydrogen, alkyl, trifluoromethyl or fluoro; and

R₄, R₅ and R₆ which can be the same or different are selected from the group consisting of hydrogen, alkyl or phenyl which may be unsubstituted or may have one or more alkyl, alkoxy, trifluormethyl or fluoro substituents;

M is ruthenium, rhodium, palladium, osmium, iridium or platinum; and

n is 1 or 2.

The dopant may also be a complex of a general formula selected from: 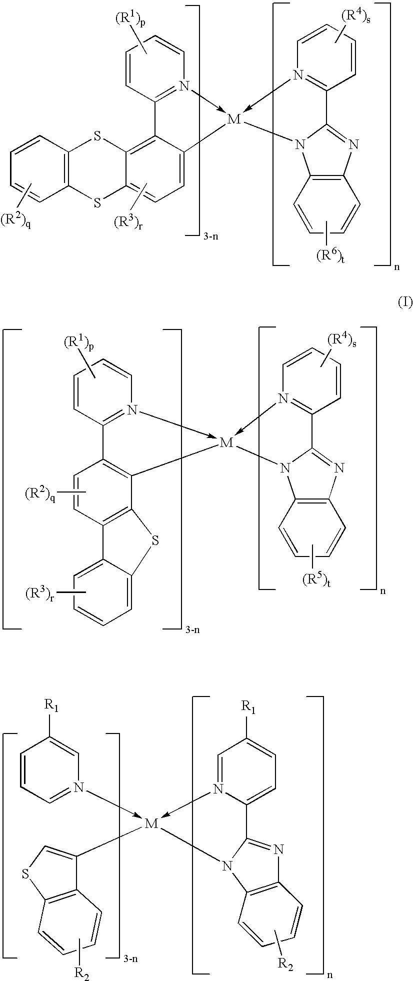
wherein

M is ruthenium, rhodium, palladium, osmium, iridium or platinum;

n is 1 or 2;

R₁, R₂, R₃, R₄ and R₅ which may be the same or different are selected from the group consisting of hydrogen, hydrocarbyl, hydrocarbyloxy, halogen, nitrile, amino, dialkylamino, arylamino, diarylamino and thiophenyl;

p, s and t are independently are 0, 1, 2 or 3, subject to the proviso that where any of p, s and t is 2 or 3 only one of them can be other than saturated hydrocarbyl or halogen;

q and r are independently are 0, 1 or 2, subject to the proviso that when q or r is 2, only one of them can be other than saturated hydrocarbyl or halogen.

In embodiments, for the lithium quinolate described above
(a) Compounds of the formula below can serve as red dopants: 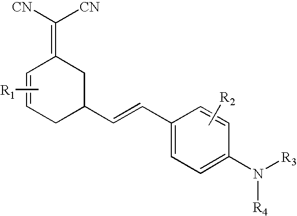
wherein R₁ represents alkyl e.g. methyl, ethyl or t-butyl, R₂ represents hydrogen or alkyl e.g. methyl, ethyl or t-butyl and R₃ and R₄ represent hydrogen, alkyl e.g. methyl or ethyl or C₆ ring structures fused to one another and to the phenyl ring at the 3- and 5-positions and optionally further substituted with one or two alkyl e.g. methyl groups. Examples of such compounds include

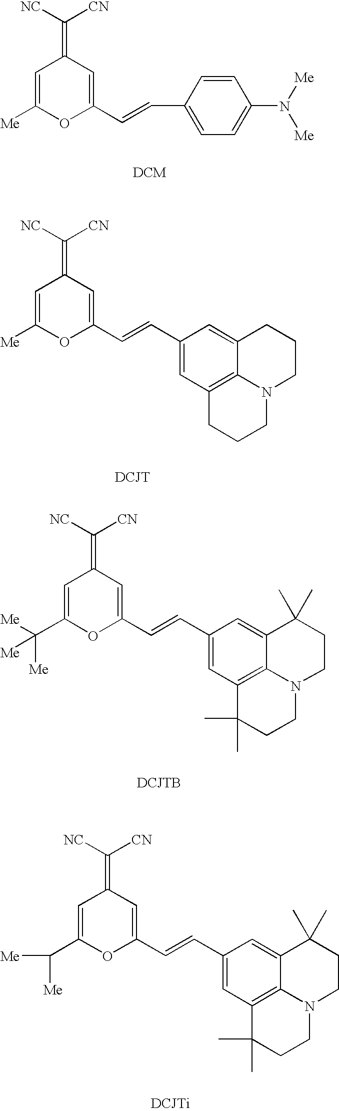

Particular phosphorescent materials that can be used as red dopants (see WO 2005/080526, the disclosure of which is incorporated herein by reference) include the following: 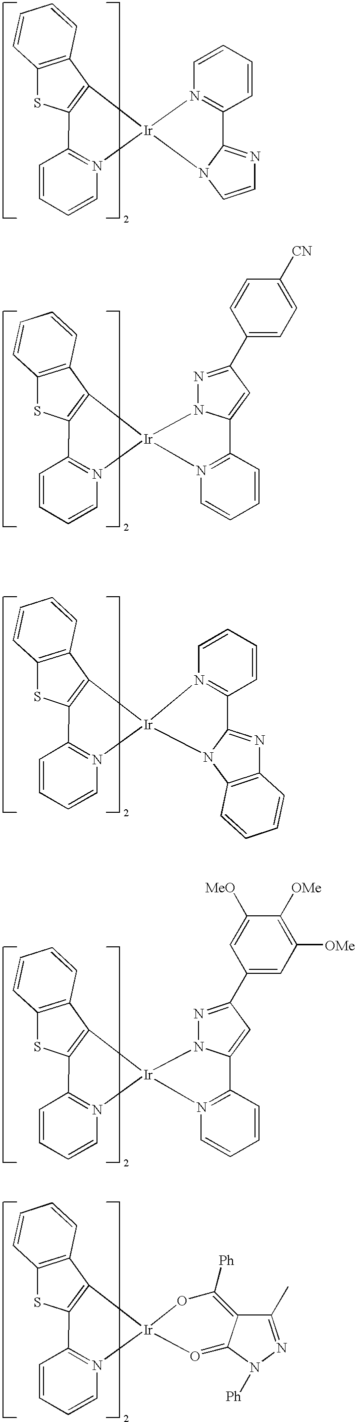 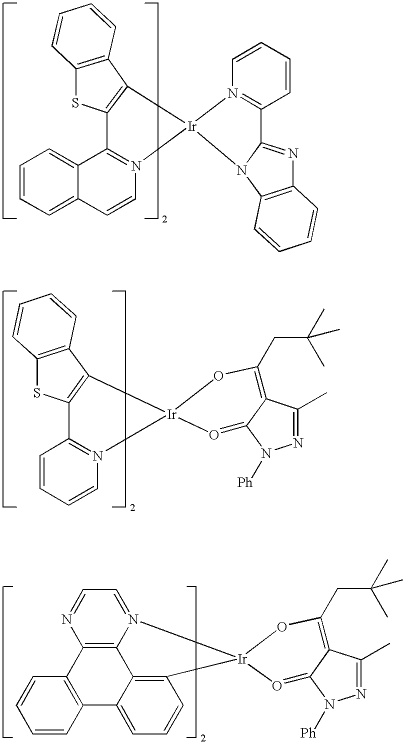
(b) The compounds below, for example, can serve as green dopants:

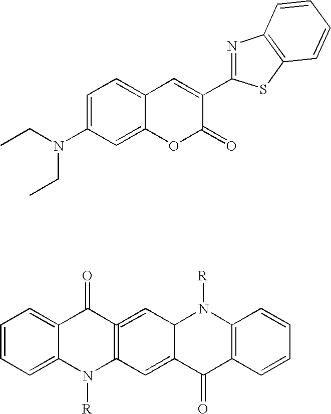

wherein R is C₁-C₄ alkyl, monocyclic aryl, bicyclic aryl, monocyclic heteroaryl, bicyclic heteroaryl, aralkyl or thienyl, preferably phenyl; and

Further phosphorescent compounds that can be used as green dopants include the following compounds (see WO 2005/080526); 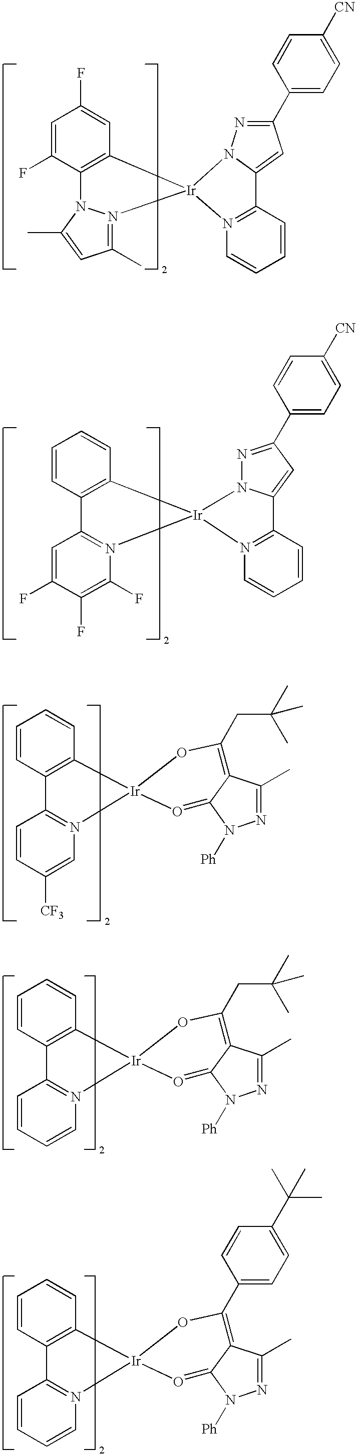
(c) The compounds perylene and 9-(10-(N-(naphthalen-8-yl)-N-phenylamino)anthracen-9-yl)-N-(naphthalen-8-yl)-N-phenylanthracen-10-amine can serve as a blue dopants.

Yet further possible dopants comprise aromatic tertiary amines including at least two aromatic tertiary amine moieties (e.g. those based on biphenyl diamine or of a “starburst” configuration) as described above as hole transport materials.

Other dopants are dyes such as the fluorescent 4-dicyanomethylene-4H-pyrans and 4-dicyanomethylene-4H-thiopyrans, e.g. the fluorescent dicyanomethylenepyran and thiopyran dyes. Useful fluorescent dyes can also be selected from among known polymethine dyes, which include the cyanines, complex cyanines and merocyanines (i.e. tri-, tetra- and poly-nuclear cyanines and merocyanines), oxonols, hemioxonols, styryls, merostyryls, and streptocyanines. The cyanine dyes include, joined by a methine linkage, two basic heterocyclic nuclei, such as azolium or azinium nuclei, for example, those derived from pyridinium, quinolinium, isoquinolinium, oxazolium, thiazolium, selenazolium, indazolium, pyrazolium, pyrrolium, indolium, 3H-indolium, imidazolium, oxadiazolium, thiadioxazolium, benzoxazolium, benzothiazolium, benzoselenazolium, benzotellurazolium, benzimidazolium, 3H- or 1H-benzoindolium, naphthoxazolium, naphthothiazolium, naphthoselenazolium, naphthotellurazolium, carbazolium, pyrrolopyridinium, phenanthrothiazolium, and acenaphthothiazolium quaternary salts. Other useful classes of fluorescent dyes are 4-oxo-4H-benz-[d,e]anthracenes and pyrylium, thiapyrylium, selenapyrylium, and telluropyrylium dyes.

Yet further phosphorescent dopants (see WO 2005/080526) include the following compounds:

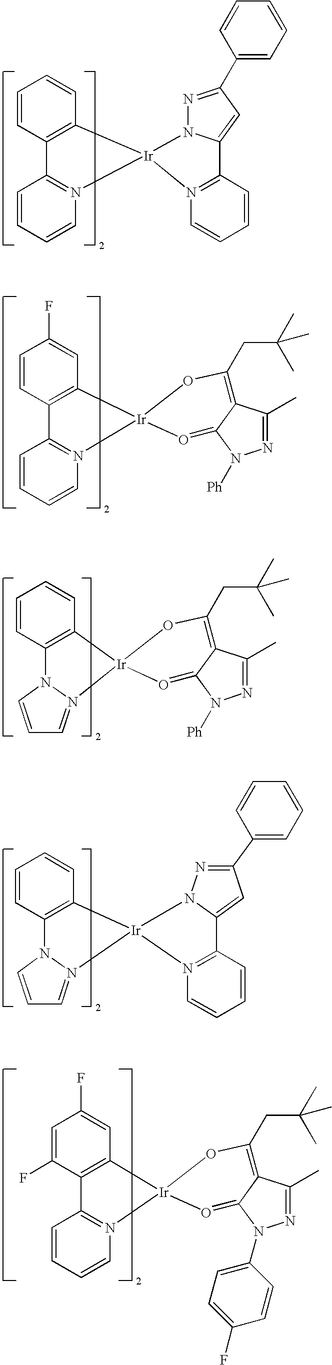

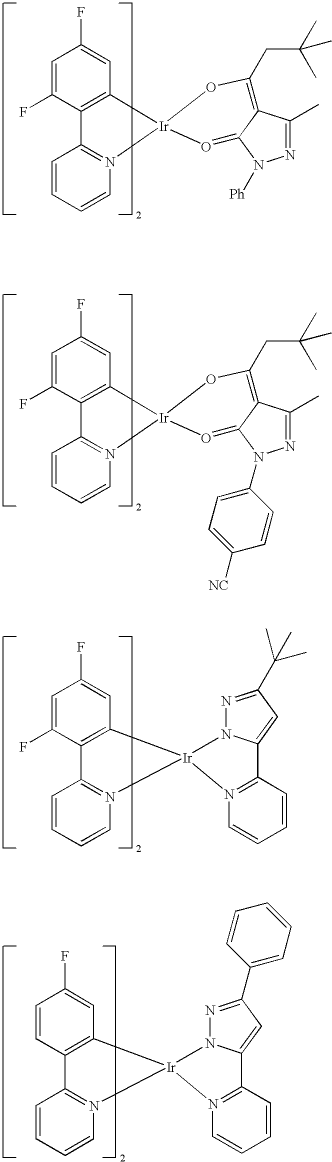

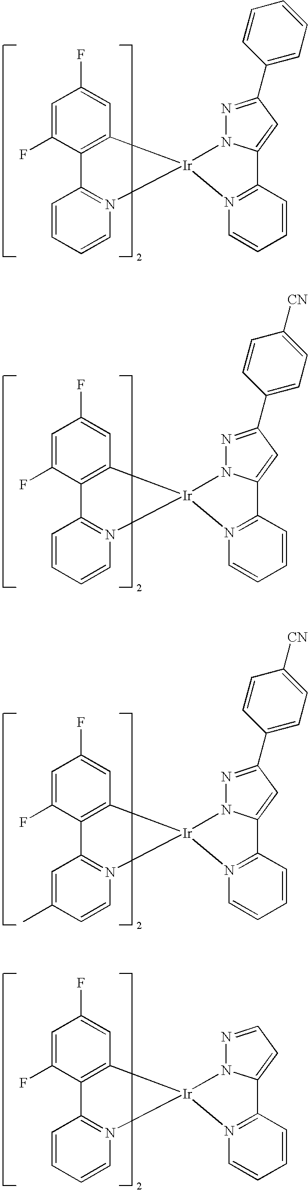

Rare earth chelates are yet further possible dopants, e.g. of the formula (Lα)ₙM or (Lα)n>M←Lp where Lα and Lp are organic ligands, M is a rare earth metal and n is the valence of the metal M. Examples of such compounds are disclosed in patent application WO98/58037 which describes a range of lanthanide complexes and also those disclosed in U.S. Pat. Nos. 6,524,727, 6,565,995, 6,605,317, 6,717,354 and 7,183,008. The disclosure of each of these specifications is incorporated herein by reference.

Electron Transport Material

Kulkarni et al., Chem. Mater. 2004, 16, 4556-4573 (the contents of which are incorporated herein by reference) have reviewed the literature concerning electron transport materials (ETMs) used to enhance the performance of organic light-emitting diodes (OLEDs). In addition to a large number of organic materials, they discuss metal chelates including aluminium quinolate, which they explain remains the most widely studied metal chelate owing to its superior properties such as high EA (˜−3.0 eV; measured by the present applicants as −2.9 eV) and IP (˜−5.95 eV; measured by the present applicants as about −5.7 eV), good thermal stability (Tg ˜172° C.) and ready deposition of pinhole-free thin films by vacuum evaporation. Aluminum quinolate remains a preferred material and a layer of aluminum quinolate may be incorporated as electron transfer layer if desired.

Further preferred electron transport materials consist of or comprises zirconium, hafnium or lithium quinolate.

Zirconium quinolate has a particularly advantageous combination of properties for use as an electron transport material and which identify it as being a significant improvement on aluminium quinolate for use as an electron transport material. It has high electron mobility. Its melting point (388° C.) is lower than that of aluminium quinolate (414° C.). It can be purified by sublimation and unlike aluminium quinolate it resublimes without residue, so that it is even easier to use than aluminium quinolate. Its lowest unoccupied molecular orbital (LUMO) is at −2.9 eV and its highest occupied molecular orbital (HOMO) is at −5.6 eV, similar to the values of aluminium quinolate. Furthermore, unexpectedly, it has been found that when incorporated into a charge transport layer it slows loss of luminance of an OLED device at a given current with increase of the time for which the device has been operative (i.e. increases device lifetime), or increases the light output for a given applied voltage, the current efficiency for a given luminance and/or the power efficiency for a given luminance. Embodiments of cells in which the electron transport material is zirconium quinolate can exhibit reduced turn-on voltage and up to four times the lifetime of similar cells in which the electron transport material is zirconium quinolate. It is compatible with aluminium quinolate when aluminium quinolate is used as host in the electroluminescent layer of an OLED, and can therefore be employed by many OLED manufacturers with only small changes to their technology and equipment. It also forms a good electrical and mechanical interface with inorganic electron injection layers e.g. a LiF layer where there is a low likelihood of failure by delamination. Of course zirconium quinolate can be used both as host in the electroluminescent layer and as electron transfer layer. The properties of hafnium quinolate are generally similar to those of zirconium quinolate.

Zirconium or hafnium quinolate may be the totality, or substantially the totality of the electron transport layer. It may be a mixture of co-deposited materials which is predominantly zirconium quinolate. The zirconium or hafnium may be doped as described in GB 06 14847.2 filed 26 Jul. 2006, the contents of which are incorporated herein by reference. Suitable dopants include fluorescent or phosphorescent dyes or ion fluorescent materials e.g. as described above in relation to the electroluminescent layer, e.g. in amounts of 0.01-25 wt % based on the weight of the doped mixture. Other dopants include metals which can provide high brightness at low voltage. Additionally or alternatively, the zirconium or hafnium quinolate may be used in admixture with another electron transport material. Such materials may include complexes of metals in the trivalent or pentavalent state which should further increase electron mobility and hence conductivity. The zirconium and hafnium quinolate may be mixed with a quinolate of a metal of group 1, 2, 3, 13 or 14 of the periodic table, e.g. lithium quinolate or zinc quinolate. Preferably the zirconium or hafnium quinolate comprises at least 30 wt % of the electron transport layer, more preferably at least 50 wt %.

Electron Injection Material

Any known electron injection material may be used, LiF being typical. Other possibilities include BaF₂, CaF₂ and CsF, TbF₃ and rare earth fluorides.

Cathode

The cathode can be any low work function metal e. g. aluminium, calcium, lithium, silver/magnesium alloys etc. In many embodiments, aluminium is used as the cathode either on its own or alloyed with elements such as magnesium or silver, although in some embodiments other cathode materials e.g. calcium may be employed. In an embodiment the cathode may comprise a first layer of alloy e.g. Li—Ag, Mg—Ag or Al—Mg closer to the electron injection or electron transport layer and an second layer of pure aluminium further from the electron injection or electron transport layer.

The invention is further described with reference to the examples.

### EXAMPLE 1

### Lithium 8-hydroxyquinolate Li(C₉H₈ON)

2.32 g (0.016 mole) of 8-hydroxyquinoline was dissolved in acetonitrile and 10 ml of 1.6M n-butyl lithium (0.016 mole) was added. The solution was stirred at room temperature for one hour and an off-white precipitate filtered off. The precipitate was washed with acetonitrile and dried in vacuo. The solid was shown to be lithium quinolate.

### EXAMPLE 2

### Lithium 8-hydroxyquinolate Li(C₉H₈ON)

A glass slide (Spectrosil UV grade) was dipped into a solution of n-butyl lithium in acetonitrile for four seconds and then in immersed in a solution of 8-hydroxyquinoline for four seconds. A thin layer of lithium quinolate was easily seen on the glass.

The photoluminescent efficiency and maximum wavelength of the PL emission of the lithium quinolate was measured. Photoluminescence was excited using 325 mn line of Liconix 4207 NB, He/Cd laser. The laser power incident at the sample (0.3 mWcm-2) was measured by a Liconix 55PM laser power meter. The radiance calibration was carried out using Bentham radiance standard (Bentham SRS8, Lamp current 4, OOOA), calibrated by National Physical laboratories, England. The compound had a CIE x=0.17. y=0.23, a Λₘₐₓ (PL)/nm of 479 and an absolute photoluminescent efficiency ηPL of 7%.

### EXAMPLE 3

### Doped Lithium Quinolate

The lithium quinolate of Example 1 was mixed with a dopant. The dopants were:

perylene

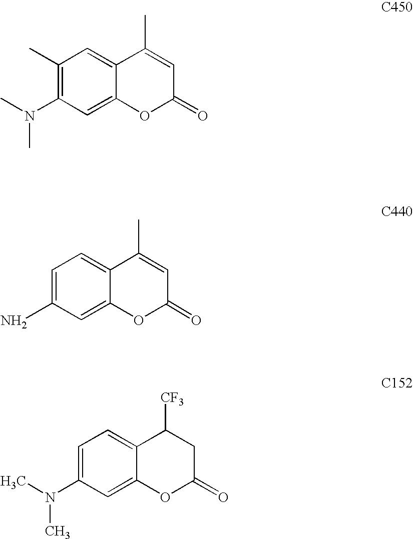

### EXAMPLE 4

### Device Fabrication

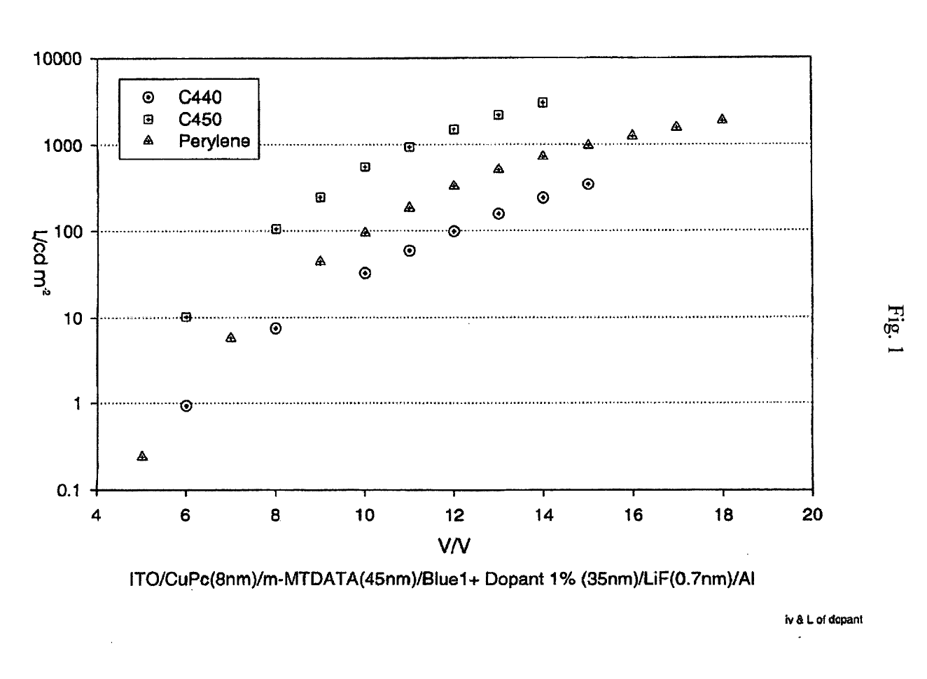

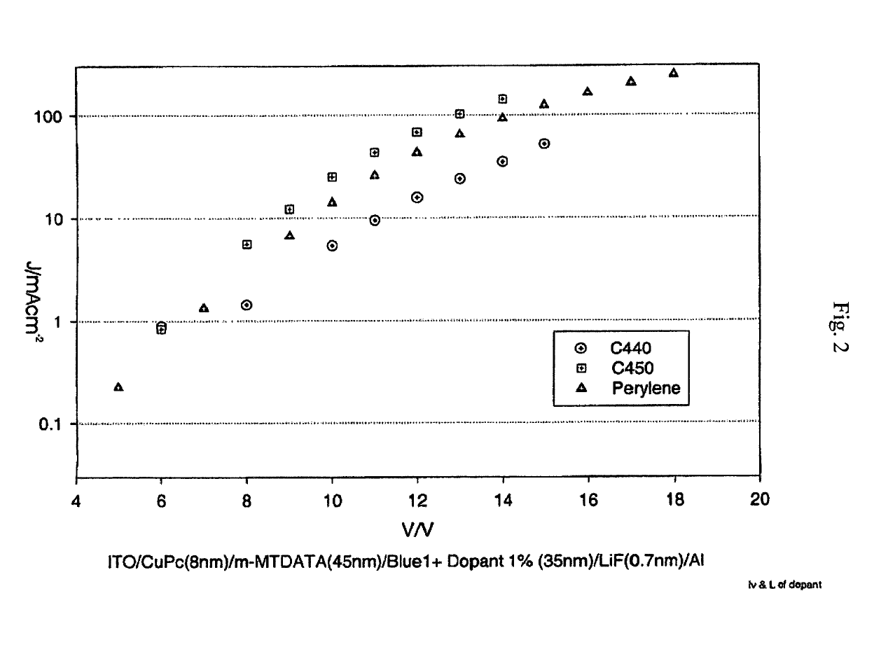

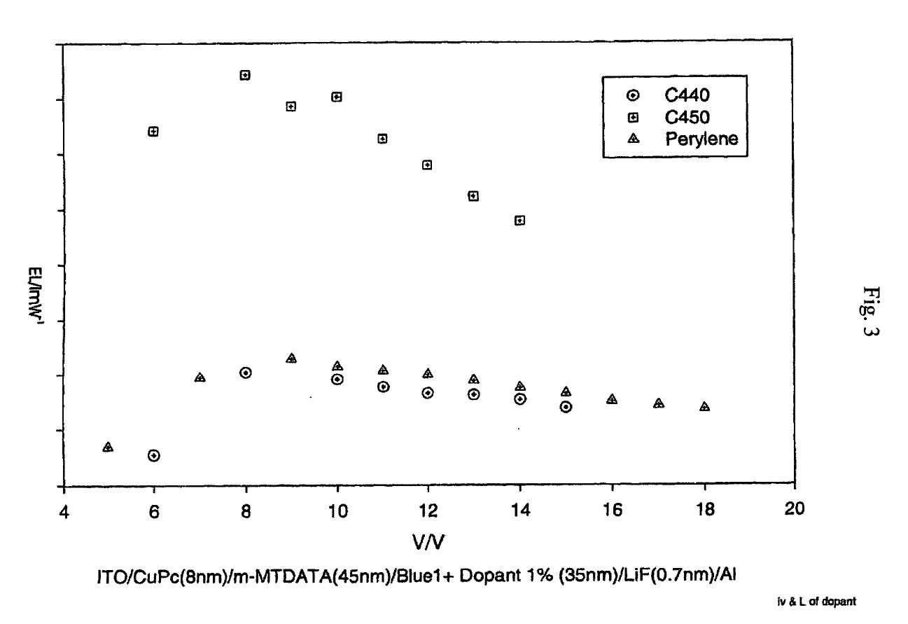

A double layer device was constructed comprising an ITO coated glass anode, a copper phthalocyanine layer, a hole transport layer, a layer of doped lithium quinolate, a lithium fluoride layer and an aluminium cathode. In the device the ITO coated glass had a surface resistance of about 10 ohms. An ITO coated glass piece about 1 cm square had a portion etched out with concentrated hydrochloric acid to remove the ITO and was cleaned and dried. The device was fabricated by sequentially forming on the ITO, by vacuum evaporation at 1×10⁻⁵ Torr, a copper phthalocyanine buffer layer, a M-MDTATA hole transmitting layer and the doped lithium quinolate electroluminescent layer. Variable voltage was applied across the device and the spectra and performance measured. The results of these tests are shown in FIGS. 1-4.

### EXAMPLE 5

### Perylene Doped Lithium Quinolate

Devices with blue emitters were formed as follows. A pre-etched ITO coated glass piece (10×10 cm²) was used. The device was fabricated by sequentially forming layers on the ITO, by vacuum evaporation using a Solciet Machine, ULVAC Ltd. Chigasaki, Japan. The active area of each pixel was 3 mm by 3 mm. The coated electrodes were encapsulated in an inert atmosphere (nitrogen) with UV-curable adhesive using a glass back plate.

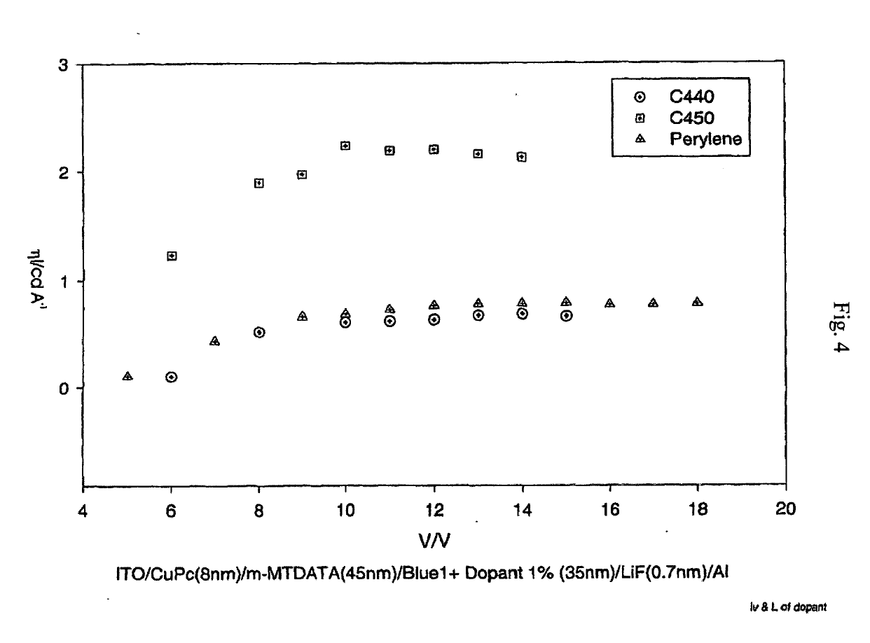

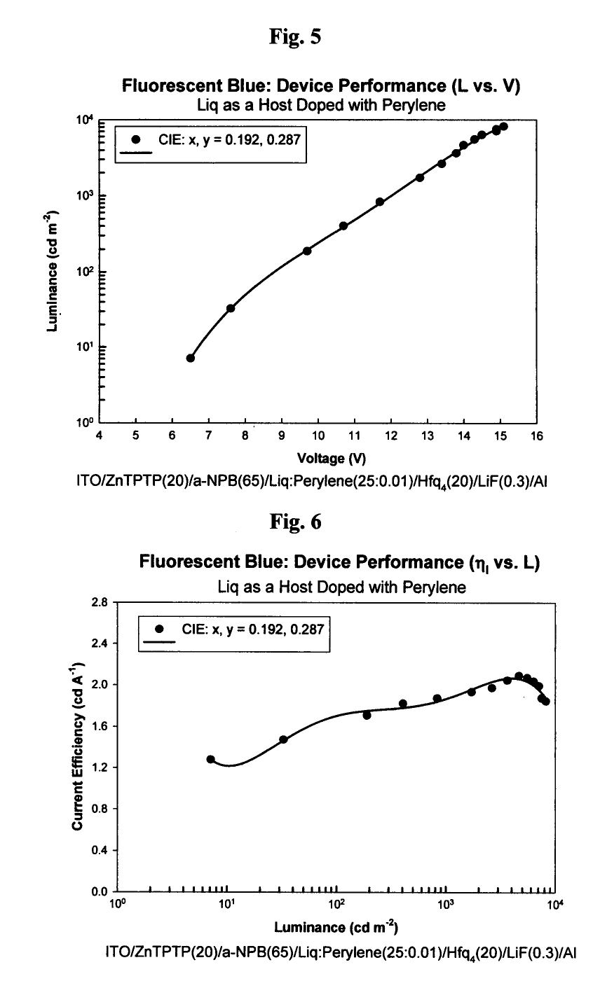

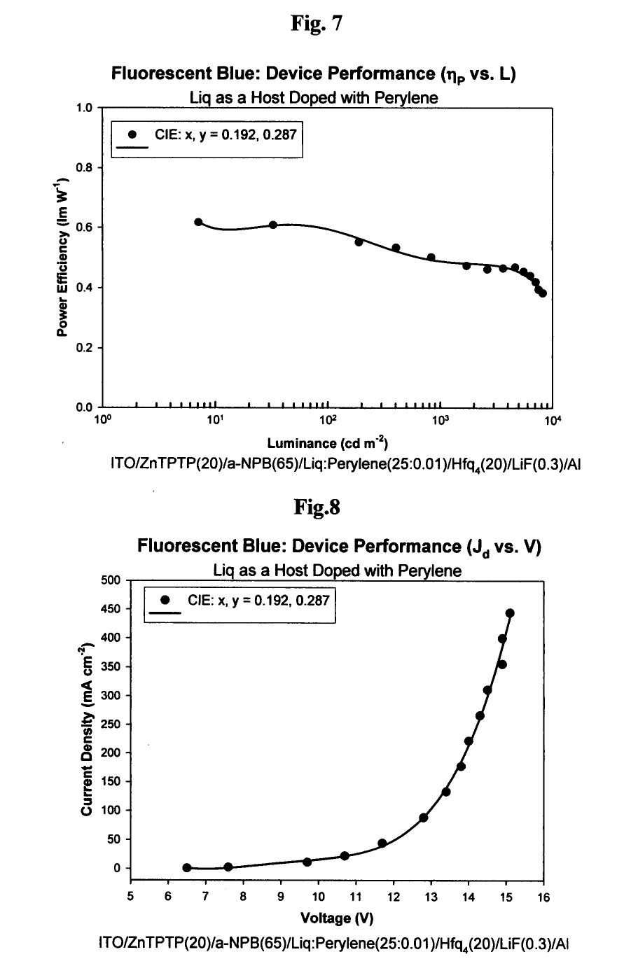

The devices consisted of an anode layer, buffer layer, hole transport layer, electroluminescent layer (doped metal complex), electron transport layer, electron injection layer and cathode layer, film thicknesses being in nm:
ITO/ZnTp TP (20)/α-NBP(65)/Liq:Perylene (40:0.1)/Hfq₄ (20)/LiF(0.3)/Al
wherein the electron injection layer is LiF. Electroluminescence studies were performed with the ITO electrode was always connected to the positive terminal. The current vs. voltage studies were carried out on a computer controlled Keithly 2400 source meter. Results are shown in FIGS. 5-8.

### EXAMPLE 6

### α-NBP Doped Lithium Quinolate

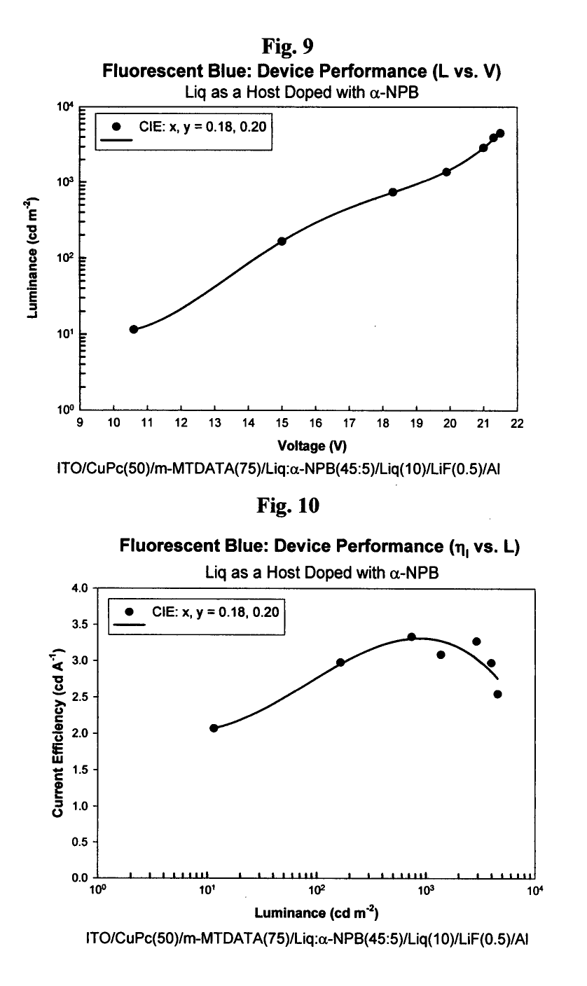

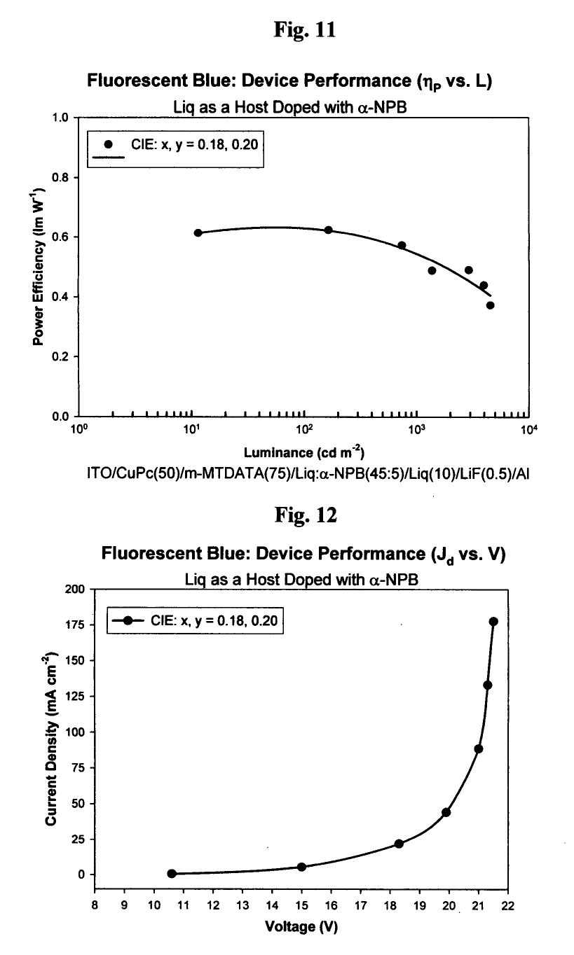

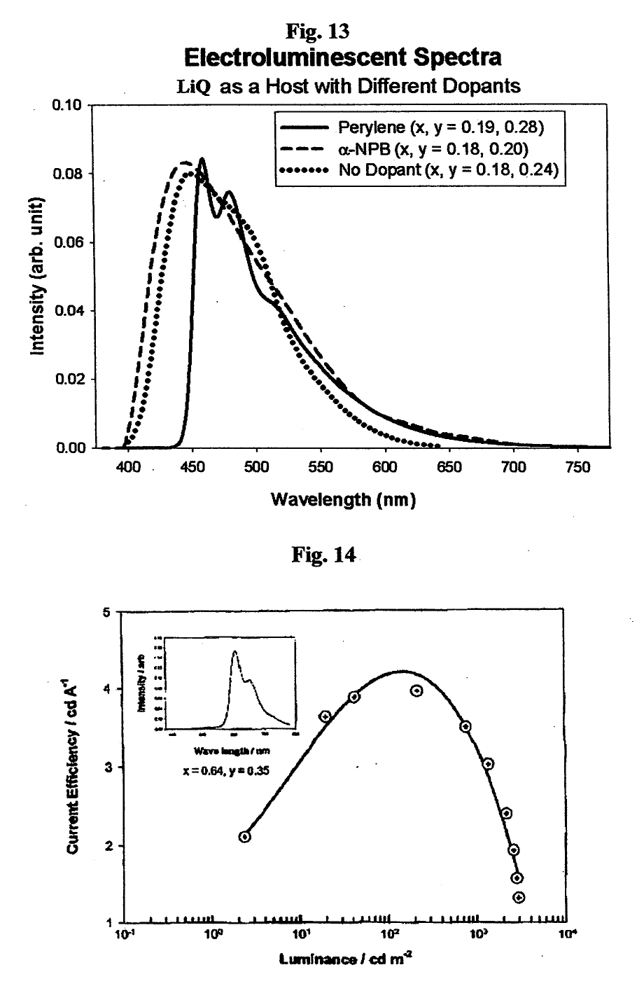

Devices were made as in Example 5 as follows:
ITO/CuPc (50)/m-MTDATA(75)/Liq:α-NBP (45:5)/LiQ (10)/LiF(0.5)/Al
Electroluminescence studies were performed as in Example 5 with results shown in FIGS. 9-12. Spectra for lithium quinolate as a host and when doped with perylene and α-NBP are as shown in FIG. 13

### EXAMPLE 7

### Bis-thiophen-2-yl-pyridine-C²,N′]-2-(2-pyridyl)-benzimidazole iridium

2-Benzo[b] thiophen-2-yL-pyridine

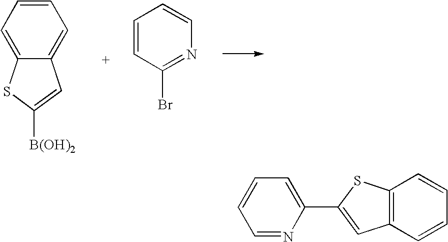

A two-necked 250 mL round-bottomed flask fitted with a reflux condenser (with gas inlet) and a rubber septum was flushed with argon before 2-bromopyridine (2.57 mL, 27 mmol) and ethyleneglycol dimethylether (80 mL, dry and degassed) were introduced. Tetrakis(triphenylphosphine) palladium (1.0 g, 0.87 mmol) was added and the solution stirred at room temperature for 10 minutes. Benzothiophene-2-boronic acid (5.0 g, 28.1 mmol) was then added, followed by anhydrous sodium bicarbonate (8.4 g. 100 mmol) and water (50 mL, degassed). The septum was replaced with a glass stopper and the reaction mixture was heated at 80° C. for 16 hours, cooled to room temperature and the volatiles removed in vacuo. Organics were extracted with ethyl acetate (3×100 mL), washed with brine and dried over magnesium sulphate. Removal of the organics yielded a pale yellow solid. Recrystallisation from ethanol yielded a colourless solid (3.9 g, 68%, two crops), m.p. 124-6° C.
Tetrakis [2-benzo][b]thiophen-2-yl-pyridine-C², N′](μ-chloro) dilridium

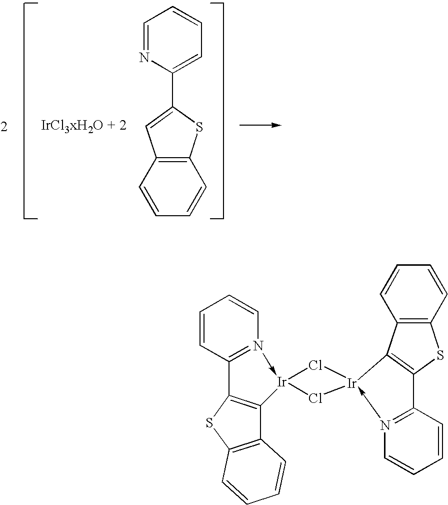

Iridium trichioride hydrate (0.97 g, 3.24 mmol) was combined with 2-benzo[b]thiophen-2-yl-pyridine (2.05 g, 9.7 mmol), dissolved in a mixture of 2-ethoxyethanol (70 mL, dried and distilled over MgSO₄, degassed) and water (20 mL, degassed), and refluxed for 24 hours. The solution was cooled to room temperature and the orange precipitate collected on a glass sinter. The precipitate was washed with ethanol (60 mL, 95%), acetone (60 mL), and hexane. This was dried and used without further purification. Yield (1.5 g. 71%)
Bis-thiophen-2-yl-pyridine-C², N′]-2-(2-pyridyl)-benzimidazole iridium

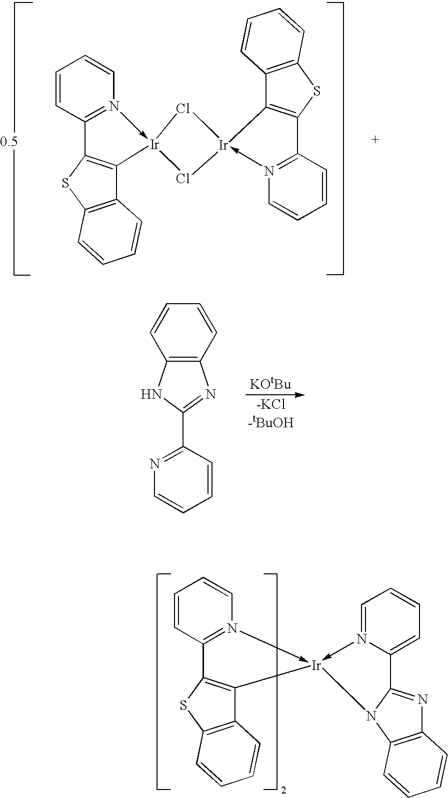

Potassium tert-butoxide (1.12 g, 10 mmol) and 2-(2-pyridyl)benzimidazole (1.95 g, 10 mmol) were added to a 200 mL Schienk tube under an inert atmosphere. 2-Ethoxyethanol (dried and distilled over magnesium sulphate, 100 mL) was added and the resultant solution stirred at ambient temperature for 10 minutes. Tetrakis[2-benzo[b]thiophen-2-yl-pyridine-C², N′](μ-chloro) diiridium (6.0 g, 4.62 mmol) was added and the mixture refluxed under an inert atmosphere for 16 hours. On cooling to room temperature, an orange/red solid separated out. The solid was collected by filtration and washed with ethanol (3×100 mL) and diethyl ether (100 mL). After drying in vacuo the material was purified by Soxhlet extraction with ethyl acetate for 24 hours. Further purification was achieved by high-vacuum sublimation (3×10⁻⁷ Torr, 400° C.). Yield (6.6 g, 89%, pre-sublimation)

Elemental Analysis:
Calc.: C, 56.56; H, 3.00, N, 8.68
Found: C, 56.41; H, 2.91; N, 8.64
   Device Fabrication

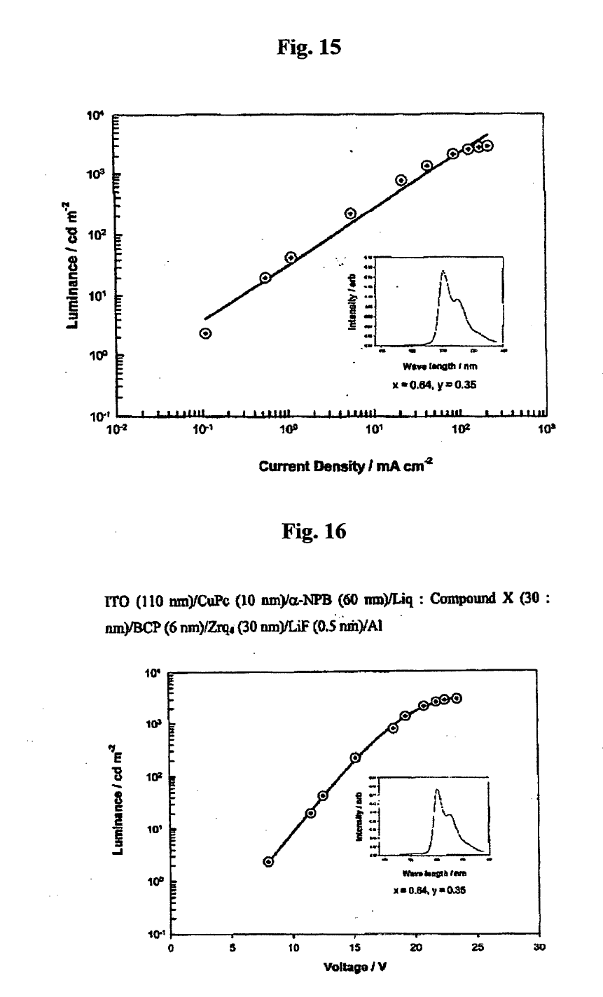

A device was fabricated of structure:
ITO(110 nm)/CuPc(10 nm)/α-NPB(60 nm)/Liq:Compound X (30:2)nm/BCP(6 nm)/Zrq₄ (30 nm)/LiF (0.5 nm)/Al
where Compound X is thiophen-2-yl-pyridine-C²,N′]-2-(2-pyridyl)benzimidazole iridium synthesised as above, CuPc is a copper phthalocyanine buffer layer, α-NPB is as shown above, Liq is lithium quinolate, BCP is bathocupron, Zrq₄ is zirconium quinolate and LiF is lithium fluoride. The coated electrodes were stored in a vacuum desiccator over a molecular sieve and phosphorous pentoxide until they were loaded into a vacuum coater Solciet Machine,ULVAC Ltd. Chigacki, Japan; the active area of each pixel was 3 mm by 3 mm, and aluminium top contacts made. The devices were then kept in a vacuum desiccator until the electroluminescence studies were performed. The ITO electrode was always connected to the positive terminal. The current vs. voltage studies were carried out on a computer controlled Keithly 2400 source meter. The electroluminescent properties were measured and the results are shown in FIGS. 14, 15 and 16.

1. An electroluminescent composition comprising:
(a) lithium quinolate which may be unsubstituted or substituted with one or more of alkyl, aryl, fluoro, cyano, amino or alkylamino exhibiting a blue electroluminescence and being the result of reaction between a lithium alkyl or alkoxide with substituted or unsubstituted 8-hydroxy quinoline in a solvent which comprises acetonitrile; and
(b) a dopant.

2. The composition of claim 1, wherein the dopant is present in an amount of 0.01-25 wt %.

3. The composition of claim 2, wherein the dopant is present in an amount of 0.01-2 wt %.

4. The composition of claim 1, wherein the dopant is a fluorescent dopant.

5. The composition of claim 1, wherein the dopant is a phosphorescent dopant.

6. The composition of claim 1, wherein the dopant is a complex of a rare earth.

7. The composition of claim 1, wherein the dopant is a coumarin or coumarin derivative.

8. The composition of claim 1, wherein the dopant is selected from the group consisting of:
compounds of chemical formula: 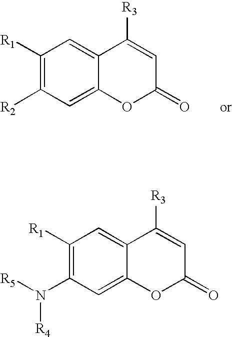
wherein R₁-R₅ represent hydrogen or alkyl, or any of the following compounds
3-(benzo[d]thiazol-2-yl)-8-(diethylamino)-2H-benzo[g]chromen-2-one,
3-(1H-benzo[d]imidazol-2-yl)-8-(diethylamino)-2H-benzo[g]chromen-2-one,
9-(pentan-3-yl)-1H-benzo[a]phenoxazin-5(4H,7aH, 12aH)-one and
10-(2-benzothiazolyl)-1,1,7,7-tetramethyl-2,3,6,7-tetrahydro-1H,5H,11H-[l]benzo-pyrano[6,7,8-ij]quinolizin-11-one.

9. The composition of claim 1, wherein the dopant is a fused-ring polycylic aromatic hydrocarbon having at least four rings.

10. The composition of claim 1, wherein the dopant is perylene or a perylene derivative.

11. The composition of claim 1, wherein the dopant is selected from perylene and perylene derivatives of the chemical formula 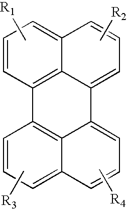
wherein R₁ to R₄ which may be the same or different are selected from hydrogen, hydrocarbyl groups, substituted and unsubstituted aromatic, heterocyclic and polycyclic ring structures, fluorocarbons, halogen, thiophenyl, substituted or unsubstituted fused aromatic, heterocyclic and polycyclic ring structures and copolymerizable monomer residues of formula —CH₂—CH═CH—R wherein R is hydrocarbyl, aryl, heterocyclic, carboxy, aryloxy, hydroxy, alkoxy, amino or substituted amino.

12. The composition of claim 11, wherein R₁ to R₄ are selected from hydrogen and t-butyl.

13. The composition of claim 1, wherein the dopant is selected from pyrene and pyrene derivatives of the chemical formula 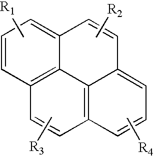
wherein R₁ to R₄ which may be the same or different are selected from hydrogen, hydrocarbyl groups, substituted and unsubstituted aromatic, heterocyclic and polycyclic ring structures, fluorocarbons, halogen, thiophenyl, substituted or unsubstituted fused aromatic, heterocyclic and polycyclic ring structures and copolymerizable monomer residues of formula —CH₂—CH═CH—R wherein R is hydrocarbyl, aryl, heterocyclic, carboxy, aryloxy, hydroxy, alkoxy, amino or substituted amino.

14. The composition of claim 1, wherein the dopant is selected from compounds of the chemical formula below: 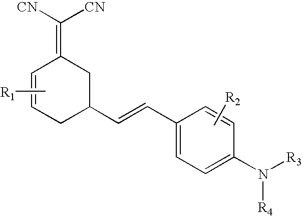
wherein R₁ represents alkyl, R₂ represents hydrogen or alkyl, R₃ and R₄ represent hydrogen, alkyl or C₆ ring structures fused to one another and to the phenyl ring at the 3- and 5-positions and optionally further substituted with one or two alkyl groups.

15. The composition of claim 1, wherein the dopant is selected from compounds of the chemical formula below:

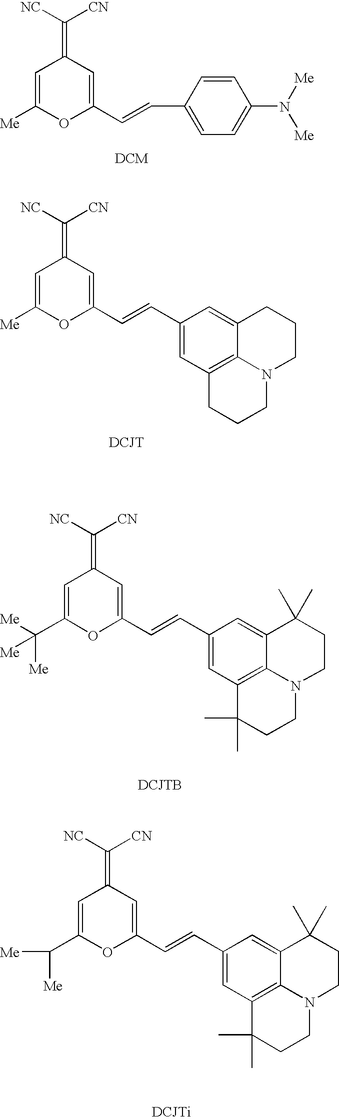

16. The composition of claim 1, wherein the dopant is a complex of a general formula selected from: 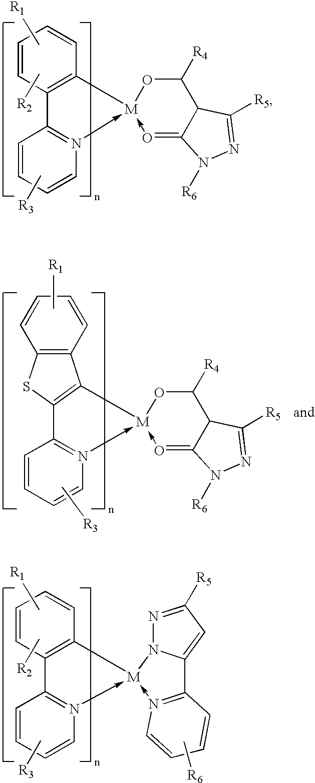
wherein
R₁, R₂, and R₃ which may be the same or different are selected from the group consisting of hydrogen, alkyl, trifluoromethyl or fluoro; and
R₄, R₅ and R₆ which can be the same or different are selected from the group consisting of hydrogen, alkyl or phenyl which may be unsubstituted or may have one or more alkyl, alkoxy, trifluormethyl or fluoro substituents;
M is ruthenium, rhodium, palladium, osmium, iridium or platinum; and
n is 1 or 2.

17. The composition of claim 1, wherein the dopant is a complex of a general formula selected from: 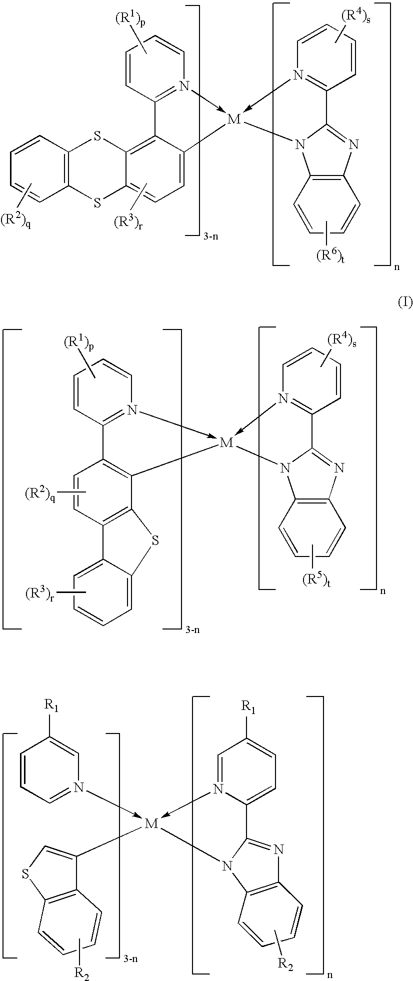
wherein
M is ruthenium, rhodium, palladium, osmium, iridium or platinum;
n is 1 or 2;
R₁, R₂, R₃, R₄ and R₅ which may be the same or different are selected from the group consisting of hydrogen, hydrocarbyl, hydrocarbyloxy, halogen, nitrile, amino, dialkylamino, arylamino, diarylamino and thiophenyl;
p, s and t are independently are 0, 1, 2 or 3, subject to the proviso that where any of p, s and t is 2 or 3 only one of them can be other than saturated hydrocarbyl or halogen;
q and r are independently are 0, 1 or 2, subject to the proviso that when q or r is 2, only one of them can be other than saturated hydrocarbyl or halogen

18. The method of claim 1, wherein the composition comprises unsubstituted lithium quinolate.

19. The method of claim 1, wherein the composition comprises unsubstituted lithium 2-methylquinolate.

20. The method of claim 1, wherein the composition comprises unsubstituted lithium 5,7-dimethylquinolate.

21. The method of claim 1, wherein the composition comprises unsubstituted lithium 5-fluoroquinolate.

22. A method for making a doped lithium quinolate which may be unsubstituted or substituted with one or more of alkyl, aryl, fluoro, cyano, amino or alkylamino and which exhibits blue electroluminescence, which comprises:
(a) reacting a lithium alkyl or alkoxide with substituted or unsubstituted 8-hydroxy quinoline in a solvent which comprises acetonitrile to form the substituted or unsubstituted lithium quinolate; and
(b) adding a dopant.

23. The method of claim 22, wherein the lithium quinolate is made by the reaction of 8-hydroxyquinoline with butyl lithium in a solvent selected from (a) acetonitrile and (b) a mixture of acetonitrile and another liquid.

24. The method of claim 22, wherein the lithium quinolate and the dopant are co-deposited on a substrate by vacuum sublimation.

25. An electroluminescent device which comprises sequentially (i) a first electrode (ii) a layer of an electroluminescent material which comprises lithium quinolate exhibiting a blue electroluminescence and doped with a dopant and (iii) a second electrode.

26. An electroluminescent composition as claimed in claim 1, comprising:
perylene or 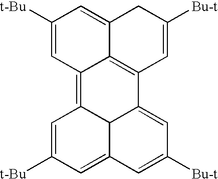
as dopant.

27. An electroluminescent composition as claimed in claim 1, comprising: 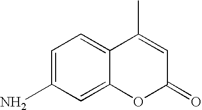
as dopant.

28. An electroluminescent composition as claimed in claim 1, comprising: 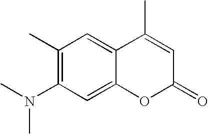
as dopant.

29. An electroluminescent composition as claimed in claim 1, comprising: 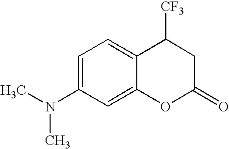
as dopant.
